(19) United States
(12) Patent Application Publication
(10) Pub. No.: US 2015/0365796 A1
(43) Pub. Date: Dec. 17, 2015

(54) A METHOD OF GENERATING AN ALERT MESSAGE

(71) Applicant: GEOREACH LIMITED, London (GB)

(72) Inventor: Karlheinz Toni, Munich (DE)

(21) Appl. No.: 14/764,413

(22) PCT Filed: Jan. 29, 2014
(86) PCT No.: PCT/GB2014/050230

§ 371 Date: Jul. 29, 2015

(30) Foreign Application Priority Data
Jan. 29, 2013 (GB) 1301576.3
Mar. 14, 2013 (GB) PCT/GB2013/050635

(51) Int. Cl. H04W 4/02; G01C 21/34

(52) U.S. Cl. CPC H04W 4/021; G01C 21/34; H04W 4/027

(57) ABSTRACT

There is provided a method of generating an alert message in a monitoring system for monitoring a plurality of mobile devices registered at a server, the system comprising the server and the plurality of mobile devices registered at the server, the plurality of mobile devices including a first mobile device, the method comprising the steps of: (i) each mobile device acquiring location data; (ii) each mobile device sending the acquired location data to the server via a telecommunications network; (iii) the server storing a time series of location data for each device; (iv) the server extrapolating a location of the first mobile device, and (v) the server generating the alert message which identifies the first mobile device in response to an extrapolated position of the first mobile device satisfying a condition.

### BACKGROUND OF THE INVENTION

1. Field of the Invention

The field of the invention relates to methods of generating an alert message in a monitoring system, and to related monitoring systems, servers, mobile devices and computer program products.

2. Technical Background

At present, even if a tracked position of a tracked object is known, identifying where that tracked object may be within a predefined time interval may not be possible.

When people are using a tracking service, the people tend to forget to bring along any additional devices apart from their mobile phones. Even if their security is at stake, any external tracking devices are often forgotten at home, or seen as an unnecessary burden.

A problem in today's tracking applications is the battery life. Gathering continuous tracking data and transmitting them to a remote server drains the battery very quickly—typically within 3-4 hours.

Current tracking solutions may provide the possibility to trigger an alert, but have little to no other predefined communication possibilities or signals for sending to an operational or monitoring centre.

Security is a major issue for people and organizations around the world. Some people and organizations pose a security threat to other people and organizations. Some people within some organizations may pose a security threat to those organizations. While mobile phone communication means that immediate communication may be possible in the case of a security incident, such as an individual telephoning the authorities to inform them that a terrorist incident has occurred, there remain significant challenges, for example for organizations to coordinate their activities speedily to protect their people in the event of an outbreak of a crisis. At present it can take a long time for an organization to find out where all its people are and whether or not each individual is safe, in the aftermath of an outbreak of a crisis. It can also take a long time for an organization to identify suspicious movements of people associated with the organization.

At present it can take a long time for an organization to find out where all its people are and whether or not each individual is safe, in the aftermath of an outbreak or a termination of a crisis.

3. Discussion of Related Art

In GB2442151B and in WO2006094335A1 there is disclosed a method and apparatus for monitoring electronic communications by way of determining the dialogue that takes place in an electronic communication. In GB2442151B and in WO2006094335A1 there is disclosed a dictionary for analysis of an electronic communication comprising a store of expressions wherein the store of expressions is arranged according to: at least one section, each section corresponding to one of a plurality of grammatical functions; at least one subject, each subject corresponding to one of a plurality of categories of expressions for facilitating monitoring of an electronic communication. In GB2442151B and in WO2006094335A1 there is disclosed a method and apparatus for monitoring an electronic communication utilising the said dictionary.

### SUMMARY OF THE INVENTION

According to a first aspect of the invention, there is provided a method of generating an alert message in a monitoring system for monitoring a plurality of mobile devices registered at a server, the system comprising the server and the plurality of mobile devices registered at the server, the plurality of mobile devices including a first mobile device, the method comprising the steps of:

(i) each mobile device acquiring location data;

(ii) each mobile device sending the acquired location data to the server via a telecommunications network;

(iii) the server storing a time series of location data for each device;

(iv) the server extrapolating a location of the first mobile device, and

(v) the server generating the alert message which identifies the first mobile device in response to an extrapolated position of the first mobile device satisfying a condition.

One problem is that current systems are only able to alert an asset to a dangerous area once the asset is within the area, which yields sometimes very unfortunate false positives, for example due to position uncertainty when the asset is not intending to enter the dangerous area. An advantage of the method is that the frequency of false positives which incorrectly identify that an asset is within an area are reduced. A further advantage is that it can be identified where a tracked object may be within a predefined time interval.

The method may be one wherein the condition is an extrapolated location of the first mobile device entering a Geofence region.

The method may be one wherein the server extrapolates a location of the first mobile device by forming a circle around the present position, the circle having a radius.

The method may be one wherein the circle radius is a predefined amount of time multiplied by an assumed speed.

The method may be one wherein the server extrapolates a location of the first mobile device by calculating routes to be covered within a predefined amount of time.

The method may be one wherein the server extrapolates a location of the first mobile device by calculating routes to get to a predefined position within a predefined about of time.

The method may be one wherein calculated routes are all viable routes.

The method may be one including the step of the server detecting the mode of travelling of the first mobile device, and using this detected mode in route calculation.

The method may be one wherein the mode of travelling is walking, in a vehicle, on a train, or on a bicycle.

The method may be one wherein the mode of travelling is a weighted average.

The method may be one wherein the server extrapolates a location of the first mobile device using historic tracking data.

The method may be one including the step of the server detecting the mode of travel of the first mobile device, and using this mode of travel in selecting historic tracking data from a store of historic tracking data.

The method may be one wherein the server extrapolates a location of the first mobile device using historic tracking data to provide a set of paths, each with an associated probability.

The method may be one wherein if the predicted paths and time dependences fail to agree with arriving at a particular destination by a particular time, an alert is generated for a user of the first mobile device that they are projected to arrive late at the particular destination by the particular time.

The method may be one including the step of an alert being generated if an extrapolated position of the first mobile device is within a predefined distance of a geofenced region.

The method may be one including the step of an alert being generated if an extrapolated position of the first mobile device is within a predefined travel time of a geofenced region.

The method may be one wherein the first mobile device includes an integral GPS receiver, and location data for the first mobile device corresponds to a GPS location of the first mobile device.

According to a second aspect of the invention, there is provided a monitoring system for monitoring a plurality of mobile devices registered at a server, the system comprising the server and the plurality of mobile devices registered at the server, the plurality of mobile devices including a first mobile device, wherein

(i) each mobile device is arranged to acquire location data;

(ii) each mobile device is configured to send the acquired location data to the server via a telecommunications network;

(iii) the server is configured to store a time series of location data for each device;

(iv) the server is arranged to extrapolate a location of the first mobile device, and

(v) the server is configured to generate an alert message which identifies the first mobile device in response to an extrapolated position of the first mobile device satisfying a condition.

The monitoring system may be arranged to perform the method of any aspect of the first aspect of the invention.

According to a third aspect of the invention, there is provided a server of a monitoring system according to a second aspect of the invention.

According to a fourth aspect of the invention, there is provided a first mobile device of a monitoring system according to a second aspect of the invention.

According to a fifth aspect of the invention, there is provided a computer program product embodied on a non-transient storage medium, the computer program product when running on a server operable to generate an alert message in a monitoring system for monitoring a plurality of mobile devices registered at a server, the system comprising the server and the plurality of mobile devices registered at the server, the plurality of mobile devices including a first mobile device, the computer program product operable to:

(i) receive location data acquired by each mobile device and sent to the server via a telecommunications network;

(ii) store at the server a time series of location data for each device;

(iii) extrapolate at the server a location of the first mobile device, and

(iv) generate at the server the alert message which identifies the first mobile device in response to an extrapolated position of the first mobile device satisfying a condition.

The computer program product may be operable to perform the method of any aspect of the first aspect of the invention.

In this disclosure, a “server” should be construed broadly to include examples such as a single server in a single location, a group of servers in a single location, a group of servers over multiple locations, or a virtual server over many locations or in the Cloud, as would be clear to one skilled in the art.

### BRIEF DESCRIPTION OF THE DRAWINGS

The above and other aspects of the invention will now be described, by way of example only, with reference to the following Figures, in which:

FIG. 1 shows an example of a method for determining if a geofence is relevant to an asset at a present position. A circle of radius Δt*v is drawn around a present position, where Δt is a time interval and v is an assumed speed. If a geofenced area is at least partly within the circle, the geofenced area is identified; if a geofenced area is not at least partly within the circle, the geofenced area is not identified.

FIG. 2 shows an example of a method for determining if a geofence is relevant to an asset at a present position. Possible tracks of the asset are plotted, and if a track enters a geofence, that geofence is identified. The circle of FIG. 1 is included in this Figure, for comparison purposes.

FIG. 3 shows an example of a sleeve for a mobile device, wherein the sleeve is for use in a monitoring system.

FIG. 4 shows an example of a sleeve hosting a mobile phone, wherein the sleeve is for use in a monitoring system.

FIG. 5 shows an example of a display of a portion of a map containing tracked assets.

FIG. 6 shows an example of an operator selecting a drawing tool.

FIG. 7 shows an example of an operator selecting an area in which the assets should be contacted.

FIG. 8 shows an example of an editable message page.

FIG. 9 shows an example of a map and a displayed list.

### DETAILED DESCRIPTION

There is provided a monitoring system for monitoring a plurality of mobile devices registered at a server, the monitoring system comprising the server and the plurality of mobile devices registered at the server, the plurality of mobile devices including a first mobile device, wherein each mobile device is arranged to acquire location data and to send the acquired location data to the server via a telecommunications network, the server storing a time series of location data for each device. The server may be configured to generate an alert message identifying the first mobile device in response to a time series of location data from the first mobile device satisfying a condition.

Mobile devices may include devices for satellite communication, covert devices, mobile phones, smart phones and tablets. Telecommunications networks may include satellite networks and terrestrial networks.

The monitoring system may be one wherein location data corresponds to a location of the corresponding mobile device.

The monitoring system may be one wherein the first mobile device includes an integral GPS receiver, and location data corresponds to a GPS location of the first mobile device.

The monitoring system may be one wherein the plurality of mobile devices each includes a touchscreen, each touchscreen displaying an icon or button which is operable to generate an SOS alert at the server in response to a single user touch of the icon or button. The monitoring system may be one wherein the plurality of mobile devices each includes a hard button which is operable to generate an SOS alert at the server in response to a single user touch of the hard button.

The monitoring system may be one wherein the monitoring system further comprises a computer system including a display, wherein the computer system is arranged to display the alert message on the display of the computer system.

The monitoring system may be one wherein the computer system is operable to receive input of a Geofence region.

The monitoring system may be one wherein the computer system is operable to receive input of a Geofence region drawn freehand on a representation of a digital map.

The monitoring system may be one wherein the computer system is operable to receive input of a Geofence region, and to display which mobile devices of the plurality of mobile devices are present in the GeoFence region in response to the received input of the Geofence region.

The monitoring system may be one wherein the computer system is connected to the server via a telecommunications network.

The monitoring system may be one wherein the computer system is connected to the server via a local network and/or via the internet.

The monitoring system may be one wherein the computer system is portable.

The monitoring system may be one wherein the condition is the first mobile device entering a Geofence region.

There is provided a method of generating an alert message in a monitoring system for monitoring a plurality of mobile devices registered at a server the system comprising the server and the plurality of mobile devices registered at the server, the plurality of mobile devices including a first mobile device, comprising the steps of:

(i) each mobile device acquiring location data;

(ii) each mobile device sending the acquired location data to the server via a telecommunications network;

(iii) the server storing a time series of location data for each device, and

(iv) the server generating the alert message which identifies the first mobile device in response to a time series of location data from the first mobile device satisfying a condition.

There is provided a computer program product embodied on a non-transient medium, the computer program product operable to generate an alert message in a monitoring system for monitoring a plurality of mobile devices registered at a server, the system comprising the server and the plurality of mobile devices registered at the server, the plurality of mobile devices including a first mobile device, the computer program product operable to:

(i) receive at the server location data acquired at each mobile device,

(ii) store at the server a time series of location data for each device,

(iii) generate an alert message identifying the first mobile device in response to a time series of location data from the first mobile device satisfying a condition.

There is provided a computer program product embodied on a non-transient medium, the computer program product operable to generate an SOS message in a monitoring system for monitoring a plurality of mobile devices registered at a server, the system comprising the server and the plurality of mobile devices registered at the server, the plurality of mobile devices including a first mobile device including a touchscreen, the computer program product operable to:

(i) acquire location data for the first mobile device

(ii) transmit acquired location data for the first mobile device to the server via a telecommunications network,

(iii) display on the touchscreen an icon or button which is operable to generate an SOS alert at the server in response to a single user touch of the icon or button, and

(iv) transmit an SOS alert to the server in response to a single user touch of the icon or button.

A personal and asset safety system can be used with a variety of phones eg. smartphones. Examples are iPhones, Blackberry devices, Windows phones (eg. Nokia) and Android devices (eg. Samsung, LG). The system employs next generation technology to keep your people and assets safe. Regardless of the smart-phone, network or country users are in, the system works across them all—seamlessly. In an example, part of the system includes an application running on a mobile device such as a phone eg. a smartphone.

Each mobile device may include a battery and a processor. Examples of mobile devices include mobile phones, smart phones, and tablets.

### Extrapolation of Movement Patterns

One problem is that current systems are only able to alert an asset to a dangerous area once the asset is within the area, which yields, sometimes very unfortunate false positives, for example due to position uncertainty when the asset is not intending to enter the dangerous area. A solution is a system which employs various algorithms to predict the whereabouts of a person based upon time rather than distance, calculating all or a plurality of viable routes to get to certain positions within a limited amount of time (typically the next 15 minutes to 1 hour). The system detects the ‘mode of travelling’, be it on foot, by bike, by car, by train/tube, by ship, by airplane or ‘resting still’. Using this information all potential routes are calculated taking past known positions and upcoming itinerary items into account to calculate the most likely routes and locations to be reached in a certain time-frame. The system also accounts for external travel resource information, delayed routes, traffic information and other relevant information provided by social media.

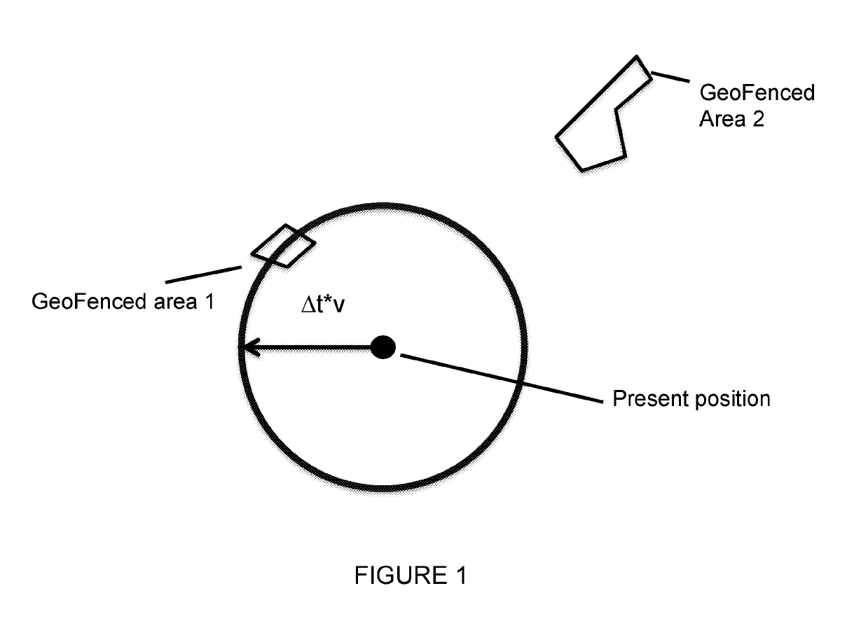

In a method of predicting a possible position of a tracked asset at a time Δt into the future, a circle is drawn around the present position of the asset on a map, in which the circle has a radius Δt*v, where v is the assumed speed of the tracked asset. So for example, if Δt=1 minute, and v is 30 kph, the circle has a radius of 500 m. An alarm may be triggered if the circle includes a predetermined area, such as a geofenced area. In this method, an alarm is not triggered if the circle does not include the predetermined area, such as a geofenced area. An example is shown in FIG. 1, in which geofenced area 1 overlaps the circle with radius Δt*v, hence an alarm is triggered in respect of geofenced area 1, but in which there is no overlap between geofenced area 2 and the circle, hence no alarm is triggered with respect to geofenced area 2.

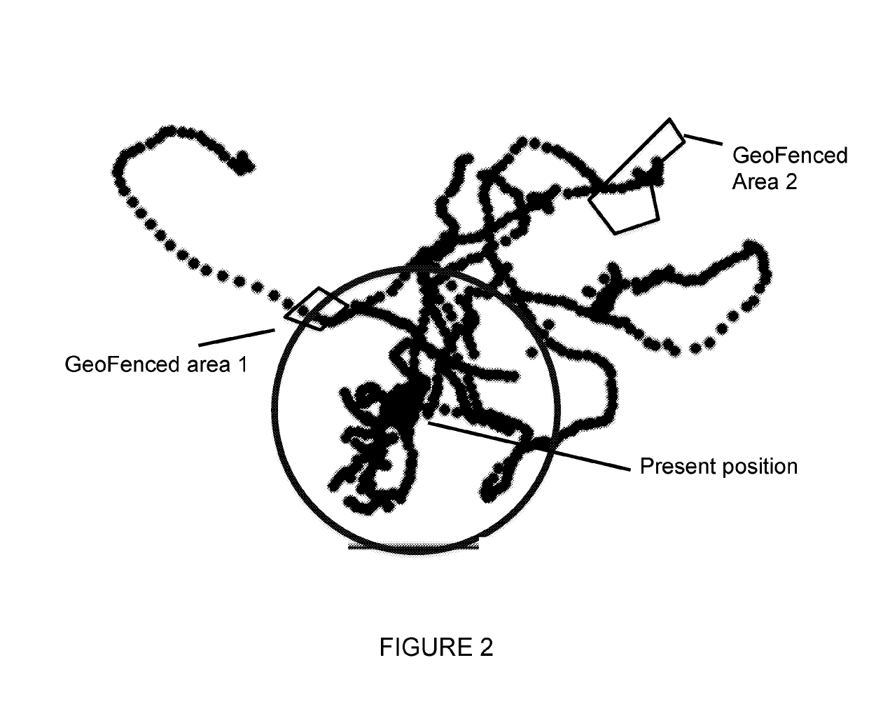

In a method of predicting a possible position of a tracked asset at a time Δt into the future, a source of external data is used to enhance the accuracy of a prediction of a possible position of a tracked asset. In an example, a source of historic tracking data is used, and historic tracks corresponding to the time period Δt are plotted on a map, the tracks starting at the present position. An alarm may be triggered if a track passes through a geofenced area. In an example shown in FIG. 2, historic tracks pass through both geofenced area 1 and geofenced area 2, hence an alarm is triggered in respect of each of geofenced area 1 and geofenced area 2. In FIG. 2, the circle of FIG. 1 is shown for comparison. FIG. 2 shows that superior predictions may be obtained if a source of external data is used to enhance the accuracy of a prediction of a possible position of a tracked asset because FIG. 2 shows that an alarm is triggered for geofenced area 2 based on historic tracking data, whereas no alarm is triggered for geofenced area 2 using the approach shown in FIG. 1.

In an example, an amber alert may be generated if an asset is determined to be in the vicinity of a geofence, even though the asset has not actually crossed the geofence. A criterion for generating an amber alert may be that the asset is within a predefined travel time of the geofence. A criterion for generating an amber alert may be that the asset is within a predefined distance of the geofence.

A movement type may be classified according to tracked data, eg. the movement is classified as being that of a car, of a train or of a person walking. A movement type may be classified using characteristics of tracked data eg. if the movement speed is always less than 5 kph, then classify movement type as walking; if movement path correlates well with train tracks, the classify movement type as train travel. This will be understood by the skilled person. An external source of data, eg. held on a third party server, may be used to enrich tracking data. If a movement type cannot be classified with a high degree of certainty, then a weighted average may be used eg. tracking data implies a 40% probability of walking and a 60% probability of being on a bus. Such a situation is possible for heavily congested traffic eg. in central London UK in morning rush hour traffic, in which traffic frequently moves only near to walking speed.

One problem is that incoming tracking signals cannot be continuous, otherwise the mobile device battery would drain much too quickly, since both acquiring a GPS fix (and maintaining it at 40-60 bit/s), as well as sending the tracking points via SMS/data transmission, is very resource intensive. A system is provided which obtains discrete tracking points with a certain time and distance interval in between and has to make intelligent assumptions about which route has been taken to get from A to B. A solution is a system which intelligently combines the speed, direction, accuracy, acceleration and position data alongside historical records and way-point/street data in order to determine the most likely route between two tracking points. In case a route should have been calculated wrongly, which will be checked by any in-between data, the system may automatically correct and learn. The system may also account for jumping GPS signals. A GPS position can jump by 30-1000 m, even though the asset has not actually moved at all, depending on a variety of external circumstances. For those instances it would be detrimental to try to acquire a route between those points because they will most likely lead to a wrong assumption about the whereabouts of an asset. Our system may automatically identify and rectify those occurrences.

Where historic tracking data implies a number of different possible paths for a given movement type (or for a probability-weighted set of movement types) a set of possible paths, each with an associated probability, may be derived. Such a set of possible paths may be obtained across all users. In an example, the set of possible paths may be weighted for a particular user. The analysis may return an array of path functions each with its associated probability. If a destination is known, this may be incorporated into the analysis.

If the predicted paths and time dependences fail to agree with arriving at a particular destination by a particular time, an alert may be generated for a user that they are projected to arrive late at the particular destination by the particular time.

If there is no historic data or too little historic data to provide a useful prediction, the analysis may default to extrapolation of the recently measured travel data to predict a travel path.

The triggering of an alert eg. warning that a user will not make a particular location by a particular time, or an alert that a dangerous area is likely to be entered, may be triggered by a probability level exceeding a threshold eg. probability exceeds 80%.

A problem is that for various reasons, position accuracy in GPS tracking is limited to about a 10 m diameter best case and about 100 m diameter on average, depending on a number of factors, such as surrounding buildings or whether one is inside or outside a building. A solution is a system which employs various algorithms to improve on the current position accuracy, performing a number of projections and assumptions combining them in a single, more precise location. Factors that are considered are: current and past accuracy, current speed and acceleration, current direction and altitude, and past positions in the surrounding region. First, an algorithm tries to identify the ‘mode of travelling’, be it on foot, by bike, by car, by train/tube, by ship, by airplane or ‘resting still’. Once the mode of travel has been identified the algorithms look at all viable route options in the surroundings of the asset accounting for current and past positions, the direction of travel and thus ruling out e.g. one-way streets, slow velocity zones or in case of a train, all non-track positions. Once all viable routes have been identified, the system tries to identify whether any of those routes lead to a position that has been visited before and measures the time it would take to get there. In case an itinerary item is known, it calculates the time remaining to the next destination and limits the routes further to those that can be reached in the time available. Finally all those assumptions are compiled into a reasonable projection and intersected with the reported position and accuracy to further improve accuracy and get a clearer understanding of where the asset might be. In case the system cannot derive sufficiently accurate information about the current position of the asset, it will request a one-off update event with maximum accuracy from the device.

To help with identification of the mode of travel, the identified path is projected onto available streets, railway lines etc. This can enable identification of the mode of travel, because the path of a user on a train is very different to the path of a user in a vehicle. Knowledge of previous paths of the same asset in the same area may be used to reduce the number of possible future paths. Knowledge of the next destination may be used to further reduce the number of possible future paths. A position may be estimated by interpolating between the previous position and the forecast position. A particular path may be given a lower weighting if the asset is determined to be moving in the opposite direction to that expected for a particular path. A particular path may be given a higher weighting if the asset is determined to be moving in the same direction to that expected for a particular path. A prediction success may be used to determine the prediction success of algorithms in predicting the position of the asset eg. based on historic data. If prediction success is good, path prediction may be continued with. If prediction success is not good, path prediction may be stopped.

### A Sleeve, a Tracking Service Sleeve

A problem is that when people are using a tracking service, the people tend to forget to bring along any additional devices apart from their mobile phones. Even if their security is at stake, any external tracking devices are often forgotten at home, or seen as an unnecessary burden. A solution is that the sleeve employs the concept of an external battery case that easily attaches to mobile phones and extends the functionality by intelligently combining it with global positioning system (GPS) and Global System for Mobile Communications (GSM)/satellite functionality, SOS, Watch-Me and check-in functionality. GSM coverage will automatically be detected and in case there is no GSM coverage the device will automatically revert to a satellite connection. The device may also feature a haptic SOS button, allowing for an SOS call to be triggered, even when the device is in a pocket. Positions will be transferred in regular intervals, which can be customized depending on whether the device is in normal mode or in SOS mode. The sleeve may feature a multi global navigation satellite system (GNSS) engine including, but not limited to GPS, GLONASS (a Russian GNSS), and Quasi-Zenith Satellite System (QZSS), Galileo and BeiDou (a Chinese satellite navigation system). It may also feature multiple antenna for maximum GSM connectivity, even in areas with poor reception.

A sleeve may function as a standalone device. A problem is that in case of an emergency your phone might be damaged and you might not have a way to call for help. Also, in areas with poor to no GSM connectivity it is impossible to connect to an emergency number via a normal phone, and satellite phones do not necessarily work whilst not having a clear view on the sky. A solution involving the use of a separate conventional device requires a user to have an additional conventional device with them. A solution is that the sleeve features a fully functional communication device with microphone and speakers which will remain fully functional even in extreme circumstances. While it does not have a dial-pad it can place a call to a pre-defined number at the press of a button either via GSM or via satellite, depending on which connection proves the most stable and robust, which will be automatically determined by the device itself.

A sleeve may include a chip to determine position based on GPS signals. A sleeve may determine position using assisted GPS (A-GPS). In A-GPS, a Network Operator deploys an A-GPS server. These A-GPS servers download the orbital information from the satellite and store it in the database. An A-GPS capable device can connect to these servers and download this information using Mobile Network radio bearers such as GSM, Code division multiple access (CDMA), Wideband Code Division Multiple Access (WCDMA), LTE (an acronym for Long Term Evolution, marketed as 4G LTE) or even using other wireless radio bearers such as Wi-Fi.

A-GPS has two modes of operation. In the Mobile Station Assisted (MSA) mode of A-GPS operation, the A-GPS capable device receives acquisition assistance, reference time and other optional assistance data from a mobile service provider. The mobile service provider continuously logs GPS information (mainly the almanac) from the GPS satellites using an A-GPS server in its system. With the help of the above data (the data received from the mobile device and the data already present in a A-GPS server) the A-GPS server calculates the position and sends it back to the A-GPS device. In the Mobile Station Based (MSB) mode of A-GPS operation, the A-GPS device receives ephemeris, reference location, reference time and other optional assistance data from the A-GPS server. With the help of the above data, the A-GPS device receives signals from the visible satellites and calculates the position.

A sleeve may switch between calculating position itself, or requesting position calculation at an A-GPS server, according to which it will minimize battery power consumption. For example, if a sleeve is receiving a strong WiFi signal, it may minimize battery power consumption to request position calculation at an A-GPS server. For example, if a sleeve is receiving a weak GSM signal, it may minimize battery power consumption to perform position calculation itself.

Indicator lights on the sleeve may indicate connectivity. An indicator light may indicate GSM connectivity state (on means connected, off means not connected). An indicator light may indicate satellite phone connectivity state (on means connected, off means not connected). Connectivity state lights may flash (eg. flash SOS in morse code) if an SOS call has been triggered.

A sleeve may be used to charge a mobile phone it is hosting. A cellular function of a sleeve may be switched off. When being charged, a sleeve may be used to charge a mobile phone it is hosting using a through-charging. A sleeve may be synched via a mobile phone it is hosting to a computer. In an example, the hosted mobile is synched first, then the sleeve is synched. In an example, the sleeve is synched first, then the hosted mobile phone is synched. The order in which the sleeve and hosted mobile phone are synched may be configurable. The order in which the sleeve and hosted mobile phone are synched may be configurable in software of the sleeve.

In normal operation, the sleeve may try to obtain a GPS fix every 5 minutes. If a GPS fix cannot be sent, it may be sent at the next opportunity. When the next opportunity to send occurs, the sleeve may re-calculate position and send the new position instead of or in addition to, the previously calculated position.

The sleeve may have its own subscriber identity module (SIM) card. The sleeve may include an integral microphone, an integral speaker or integral speakers, and no dial pad.

The sleeve may include buttons eg. red and green buttons. A short press on the buttons may make a SOS call. A long press on the buttons may make a call to a support centre, using a predefined number which is called.

The sleeve may have a battery. The battery may have about the same capacity as a battery of a mobile phone, in which case the sleeve doubles the battery capacity compared to a mobile phone on its own. A sleeve may function as a standalone device.

A sleeve and a mobile phone hosted by the sleeve may be paired using Bluetooth. An advantage is that with no physical electrical connection between the devices, the sleeve-mobile phone system is more robust against moisture eg. rain. Bluetooth functionality may be integrated into the sleeve. If Bluetooth connectivity between the sleeve and the mobile phone is lost or if the Bluetooth signal strength falls below a predetermined level, a separation between the sleeve and the mobile phone can be detected immediately, and a notification of the separation may be sent by the sleeve (and/or by the mobile phone) to a central server.

The sleeve may be paired to devices in addition to a mobile phone, using Bluetooth. If Bluetooth connectivity between the sleeve and a device other than the mobile phone is lost or if the Bluetooth signal strength falls below a predetermined level, a separation between the sleeve and the device other than the mobile phone can be detected immediately, and a notification of the separation may be sent by the sleeve (and/or by the mobile phone) to a central server.

Determined positions of the sleeve may be buffered in the sleeve or the mobile phone hosted by the sleeve. For example, positions derived from accelerometer data may be buffered. Buffered position data may be sent in bulk.

An interval between GPS fixes may be configurable eg. every 6 minutes. An interval between transmissions of GPS fixes may be configurable (eg. every 20 minutes), and may be independently configurable of the interval between GPS fixes.

The mobile phone and/or sleeve may be configured to provide a selectable “Watch-Me” mode, which indicates to a control centre that although an SOS alert is not necessary, the user is feeling uneasy about the present circumstances. In a “Watch-Me” mode, the time between GPS fixes may be reduced eg. from 6 minutes to 2 minutes. In a “Watch-Me” mode, the time between transmissions of GPS fixes may be reduced eg. from 20 minutes to 5 minutes.

Following an SOS call, the time between GPS fixes may be reduced eg. from 6 minutes to 1 minute. Following an SOS call, the time between transmissions of GPS fixes may be reduced eg. from 20 minutes to 1 minute.

The sleeve may be waterproof. The sleeve may be shock-resistant.

Positional data received at a central server may be accumulated. For example, if a user is linked to a plurality of devices (eg. a mobile phone, a sleeve, and a further mobile phone), the data can be analysed to see if the plurality of devices are together. If the devices are together, their positions may be averaged, to obtain a more accurate position of the user.

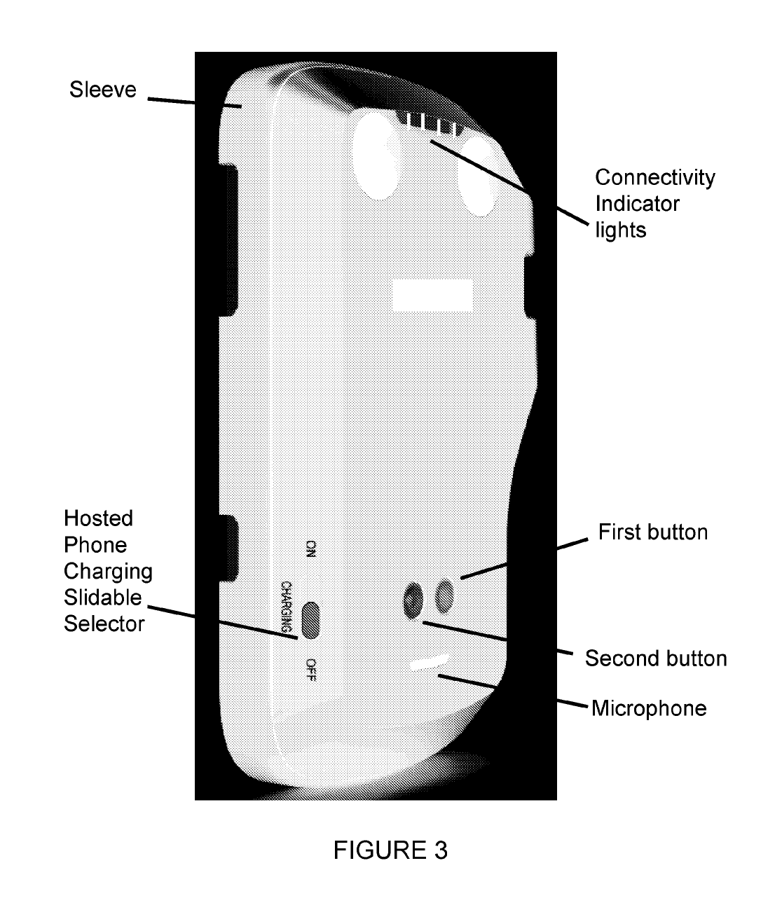

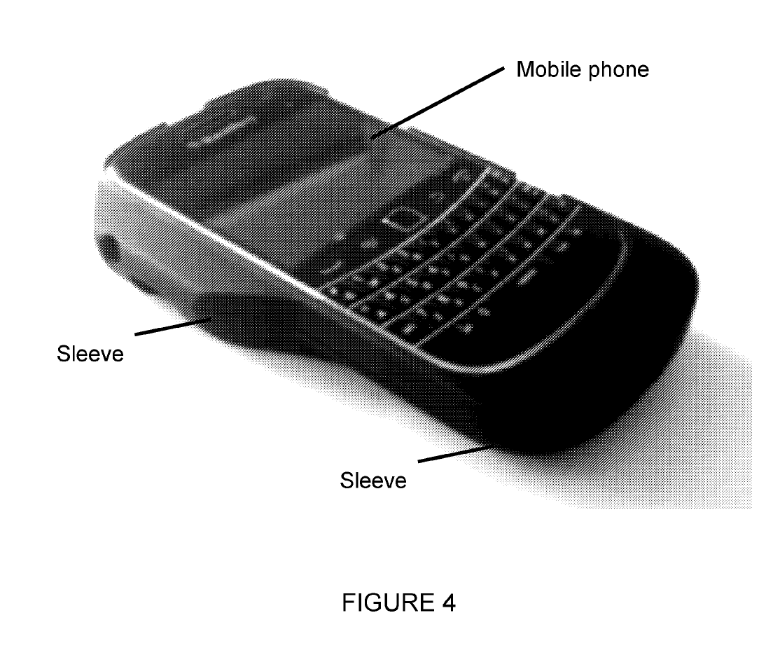

A sleeve may include indicator lights each of which indicates a connectivity state of a communication medium (eg. GSM, satellite phone, WiFi etc.). A sleeve may include first and second buttons, operable to select a sleeve function (eg. send SOS, communicate with a call centre). A sleeve may include a microphone. A sleeve may include a slidable selector for selecting a charging state (eg charge hosted mobile phone, or don't charge hosted phone). A sleeve may include a slidable selector for selecting a GSM state (eg GSM on, or GSM off). An example of a sleeve is shown in FIG. 3. Just because a sleeve is referred to as a “sleeve” does not mean that the sleeve necessarily has to surround a mobile device it is hosting in the same way that a sleeve of a garment surrounds an arm. In the example of FIG. 4, a sleeve is hosting a mobile phone.

Current GPS chips perform complex calculations in order to retrieve a GPS fix (in a cold start) and process about 60 bits of data per second for any later fixes. This can be a huge battery drain. Our GPS chip collects the raw NMEA strings and transfers those to our servers for real-time processing either via GSM or via satellite. This way, data can be collected continuously, while the transfer itself only happens in discrete situations resulting in a lower power consumption than for normal GPS chips.

A passive GPS chip may be provided, in a sleeve, or in a mobile device. The sleeve or mobile device may collect NMEA (National Marine Electronics Association) strings which include data relatable to location, and send them to a server, so that the server may perform calculations to determine the location. The sleeve or mobile device may be passively activated by GPS frequencies. The sleeve or mobile device may include an antenna that can be activated by GPS frequencies. The antenna then sends data to a module which then sends the data to servers. Performing calculations on a server to determine position may save battery power at the sleeve or mobile device. The benefit in battery power saved depends on the signal strength received at the sleeve or mobile device. Smart switching between server-based calculations and sleeve or mobile device-based calculations may be performed, depending on connectivity between the server and the sleeve or mobile device. A passive GPS chip may be smaller than a standard GPS chip, because the chip may not need to perform position calculations locally, if they are performed remotely at a server.

### Battery Life Improvement

A problem in today's tracking applications is the battery life. Gathering continuous tracking data and transmitting them to a remote server drains the battery very quickly—typically within 3-4 hours. A solution is a system which uses a combination of various algorithms to detect whether a position has changed and when to acquire the next position. This happens in a combination of mobile handset and server-side algorithms, accounting for motion detection, acceleration, cell-ID changes, current direction and speed. This way, continuous tracking is not relevant, but the approach is to calculate when to acquire the next signal in order to get enough information about the whereabouts of an asset in order to ascertain its safety. In the case in which the system is sufficiently certain about the current and future whereabouts of the assets it will delay any future updates from the device in order to limit battery impact of the application to a required minimum. For example, if the system is certain or highly confident that the asset is currently ‘standing still’ it will require the next update only once the application determines a significant location change, which is especially important to save battery charge during indoor meetings and appointments. Also, in the case in which an asset is currently travelling by train, a position update will not be required until the most anticipated point of time when the asset is due to arrive at the most likely final destination.

To save battery charge, the mobile device monitors its own position and if no position change is detected, position sending frequency is reduced; it may be reduced to not sending position at all. This minimizes battery power consumption. For example, a phone may detect it is not moving based on data from its integral accelerometers. For example, a phone may detect it is not moving based on three GPS signals implying the same location to within an uncertainty level. Position and position uncertainty may be obtained from a GPS chip integral to the mobile device. A GPS chip may also return a speed and a direction of movement. If the speed is below a threshold level for longer than a threshold time period, the mobile device may conclude it is not moving. If the mobile device detects movement, position sending may be resumed.

One way for a mobile device to investigate if it may be moving is to see if GSM cell IDs have changed since the previous time they were checked. If it is determined that the mobile device may be moving, the next step may be to obtain a GPS fix to see if indeed the device has moved since the previous GPS fix. If the GPS fix indicates that there has not been a significant movement, the mobile device may remain in a ‘rest mode’ to conserve battery power.

Battery charge on a mobile device may be saved by a system including the mobile device and a backend server, in which the server instructs the mobile device how to behave so that it will save battery charge. For example, the server may instruct the device when it should send the next update eg. a position update. Battery saving can result from reducing the number of transmissions from the mobile device, without losing information which could impact asset safety. The mobile device (eg. mobile phone) may function autonomously between communications with the back-end server. A GPS chip may be kept in a “warm state”, so it can perform a “warm start” when calculating its new position. An example of a “warm start” is when a GPS device remembers its last calculated position, almanac used, and UTC Time, but not which satellites were in view. The GPS device then performs a reset and attempts to obtain the satellite signals and calculates a new position. The receiver has a general idea of which satellites to look for because it knows its last position and the almanac data helps identify which satellites are visible in the sky. The backend server may instruct the mobile device to calculate the GPS position with the lowest selectable accuracy level, so as to reduce battery power consumption. The server may interrogate the mobile device to determine the GPS chip being used by the mobile device, and then select the accuracy level of the GPS position determination, so as to achieve a required level of accuracy.

The server may interrogate the mobile device to find out its battery charge level. The frequency of position reports from the mobile device requested by the server may be adjusted in relation to battery charge level. For example, if a battery charge level is only 20% of maximum charge, the frequency of position reports from the mobile device requested by the server may be halved. A low battery state may be defined as when only 2 hours of mobile device operation remain. In response to determination of a low battery state, the server may instruct the mobile device differently, so as to conserve mobile device battery power. The server may perform a trade off calculation, in which it adjusts the instructions sent to the mobile device in response to a decreasing battery charge level. Updates from the device following an SOS alert may be reduced by the server, in response to a low battery charge level.

An advantage of having a server determine the frequency of position updates from a mobile device is that the server is more secure than the mobile device. A mobile device could be manipulated by a hacker, for example.

It is known that for a mobile device, GPS position monitoring can be a drain on the battery. In the event that a GeoFence is identified (eg. as dangerous), the server can immediately perform a reverse lookup of cell towers that intersect with the GeoFence. This lookup would deliver to the server a number of cell-tower IDs (alongside MCC, MNC, LAC) that may be transferred to the phone and can easily be checked by the application on the mobile phone with no noticeable battery impact. In case an asset detects one of those cell-towers, the frequency on the phone to send in data could change and we could receive an automated alert pinning down the exact position of the asset.

This way, the monitoring system does not have to exclusively rely on the path prediction, but also have a safety fallback net with the surrounding cell towers that has virtually no impact on battery life. Additionally, this can be performed on the phone itself and thus has no delay in alerting the asset to specific dangers in the surrounding.

### “Watch-Me” Mode

Current tracking solutions only provide the possibility to trigger an alert, but have little to none other predefined communication possibilities or signals for sending to the operational centre.

A mobile device may send a “watch-me” signal to an operational centre. This signal may inform the operational centre that the asset is in a situation that it does not feel comfortable with and would like to be very closely monitored by the operators, potentially being provided additional advice. The difference to a panic alert is that the asset is in no immediate danger. The watch-me signal will tell the device to increase the frequency with which signals are being sent in to the operational centre and is accounted for any interpolation and/or extrapolation calculations.

The watch-me alert provides the operations centre with an additional flag. The time between position updates sent by the mobile device to the operational centre will typically be reduced. In particular, care is taken that the time between position updates sent by the mobile device to the operational centre do not exceed a predefined threshold. However, the time between position updates sent by the mobile device to the operational centre may be extended if battery level becomes low. The watch-me signal is set by a user using the mobile device, and is displayed in an operations centre in a special way. In an example, a slidable input scale is provided on the mobile device for a user to indicate a degree of concern, from a minimum level to a maximum level.

In a watch-me mode, two way communication between a mobile device and an operations centre may be provided.

### Check-in Signal

This signal from a mobile device to an operations centre informs the operations centre about the most current position of the asset and confirms that the asset is in an OK state. It may also inform the operations centre that an asset has met an appointment or eg. has arrived at an airport.

### Integration of Cameras eg. in CCTV

In an example, there is provided integration of closed circuit television (CCTV) cameras with intelligent display on approaching assets or on likely approaching assets. The system may account for the angle of the camera, day/night visibility, or the sight-distance/radius. Instead of displaying all CCTV cameras all the time to our operators, only such cameras are displayed/highlighted that are deemed to provide information about any tracked asset. The system automatically determines whether the asset is likely to be within the sight radius of a CCTV camera and queues those CCTV cameras to be shown to the operators once the asset is in sight. The system also automatically determines whether the CCTV stream is flickering or unavailable—even for a single millisecond, and highlights those events to the operator so further action can be taken to investigate if there has been any tampering with the CCTV streams. Camera flickering may be detected, to enable investigation of whether a video feed has been interrupted. A camera video feed may be analysed to look for evidence of a repeat in the video feed from the camera, which is likely to indicate tampering with the camera.

In a database at an operations centre, data for a set of cameras is stored. The data may include data which characterizes if a camera is static, rotatable, or movable. In a display mode at an operations centre, a displayed camera image is the one which best displays the tracked asset as the asset moves. So the system automatically selects between available camera images for the asset so as to display a best image for the tracked asset. An advantage is that an operator does not need to search through available camera images to find a best image, such as needing to click on a camera image, and can instead concentrate on the image provided to look for possible dangers posed to the asset. In an example, all camera images for which the camera is within a predefined distance from the asset are displayed on a screen at an operations centre.

An operator may perform due diligence ahead of time to view camera images in a place through which an asset is intended to pass. An operator may perform due diligence ahead of time to view camera images along a simulated route along which an asset is intended to pass.

An operator may select a set of camera images of an area, so that a computer-generated three dimensional model of an area may be generated. Camera images of an area may be recorded that are 360 degree images, so that a computer-generated three dimensional model of an area may be generated.

### Fast Alert

At an operations center, an operator may draw a geofence on a map, and in response, the system automatically alerts all assets within the geofence area. A fast and simple process. In addition, a list of who is safe is provided automatically by the system, the list including the assets which were previously inside the geofence area, but which are now outside the geofence area. A further list is provided of those who have not been inside the geofence area. A further list is provided of those who have confirmed they are OK, subsequent to the definition of the geofence area. These lists enable staff at the operations centre to then concentrate on those who are inside the geofence area, or whose position is unconfirmed. Based on the other lists, a priority list is generated automatically of those who are inside the geofence area, or whose position is unconfirmed, so that staff at the operations centre can then concentrate on those on the priority list.

There is provided a monitoring system for monitoring a plurality of mobile devices registered at a server, the system comprising the server and the plurality of mobile devices registered at the server, wherein each mobile device is arranged to acquire location data and to send the acquired location data to the server via a telecommunications network, the server storing a time series of location data for each device, wherein the monitoring system further includes a computer system including a display, wherein the computer system is operable to receive input of a Geofence region, and to send immediately an alert to mobile devices of the plurality of mobile devices which are present in the GeoFence region, in response to the received input of the Geofence region.

In a display of a map of tracked assets at an operations center, a weather layer (eg. indicating temperature, precipitation, rain or snow) may be displayed on the map of tracked assets.

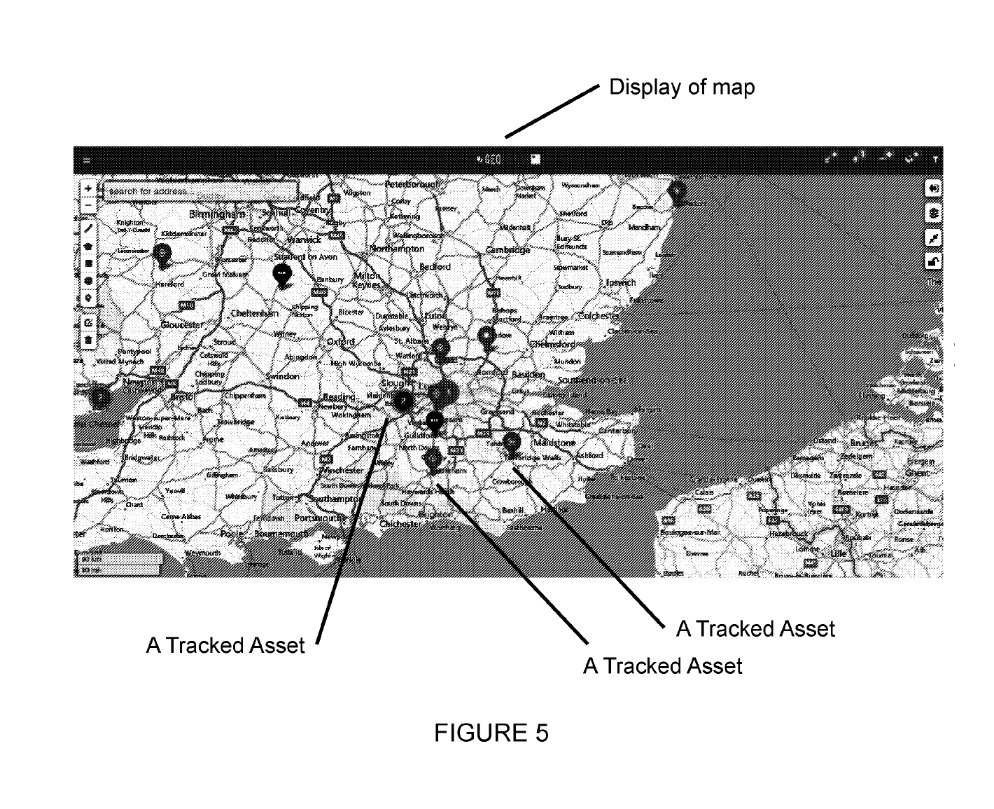

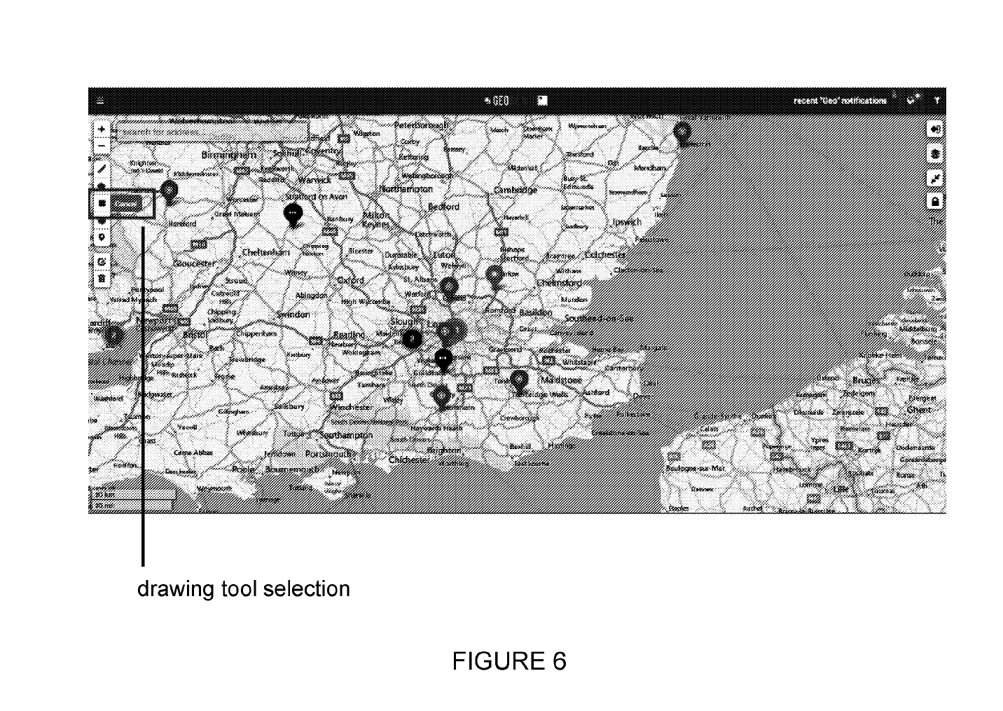

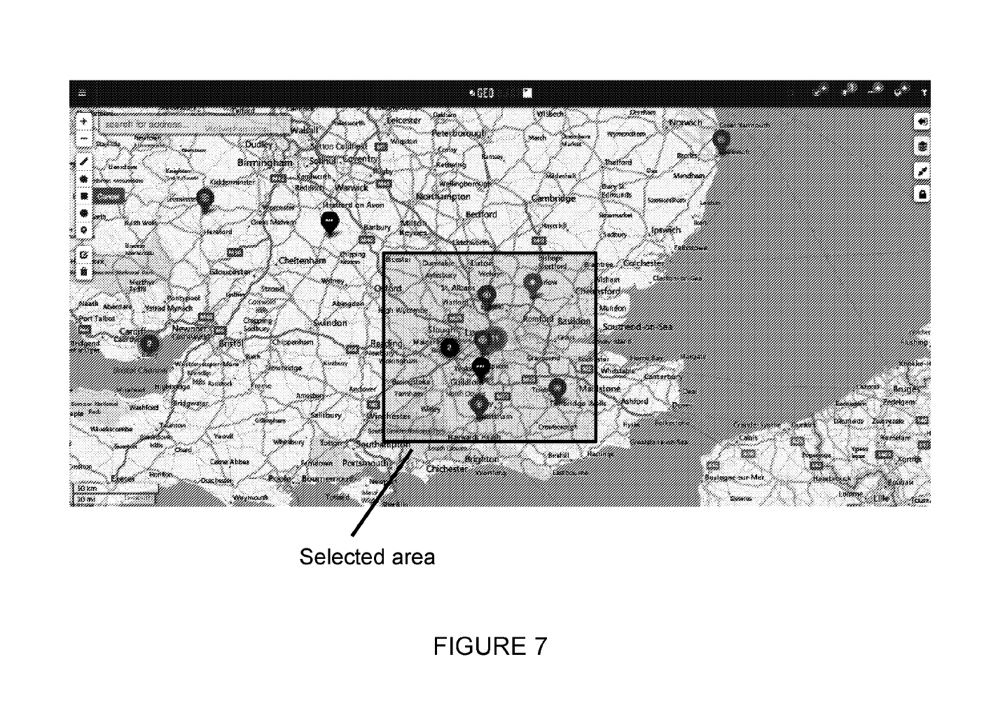

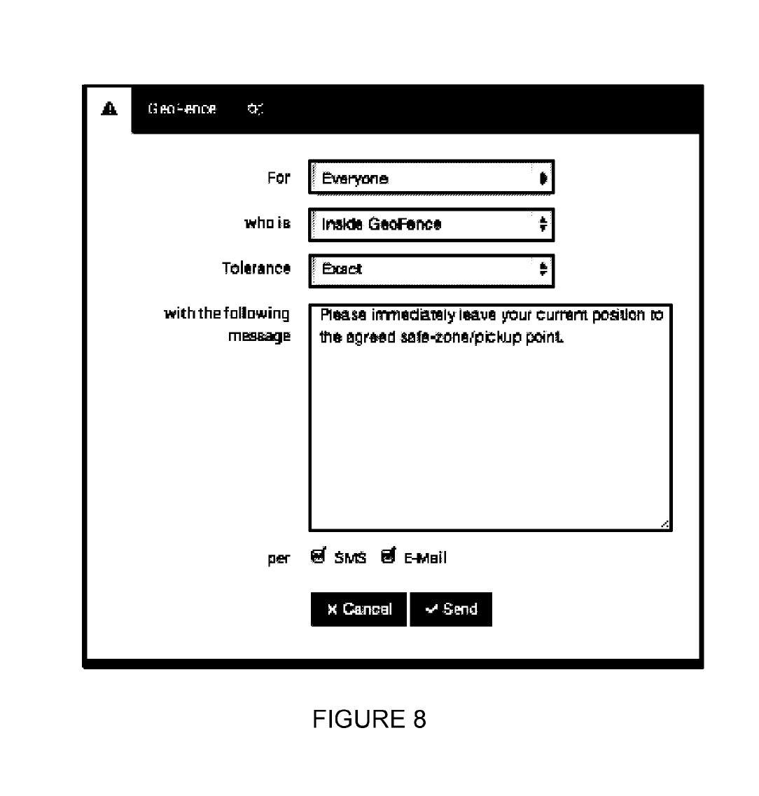

In an example of immediate messaging, an operator sees a display of any portion of a map containing tracked assets. An example is shown in FIG. 5. Then, then operator selects a drawing tool. An example is shown in FIG. 6, in which the operator selects a drawing tool on the left hand side of the screen. Then, the operator selects the area in which the assets should be contacted. An example is shown in FIG. 7. Then, an editable message page is displayed, with selectable options for who to contact, where they are located, what position error tolerance is to be applied, and what message to send, and whether or not to use email and/or SMS (an example is shown in FIG. 8). The message page may include default immediate contact options. Other available options may include:
“FOR”:
   Everyone
   Selected Entities: filter by device, asset, group, organisation
“WHO IS”:
   Inside GeoFence: area that has been selected already
   Outside GeoFence: everyone whose current position is outside the area that has been selected already
   Outside GeoFence within same Country: everyone whose current position is outside the area that has been selected already but within the respective intersecting country/countries
“TOLERANCE”:
   Exact Tolerance
   10 m
   100 m
   1,000 m
   10,000 m

Pressing or selecting ‘send’ on the screen confirms to send the message as configured by the options specified.

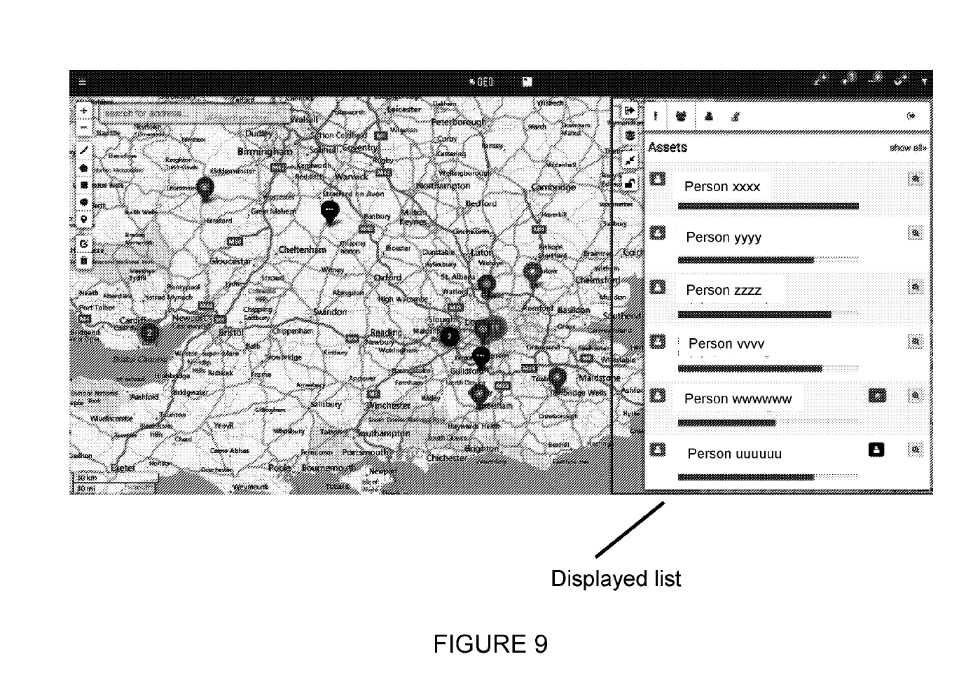

In an example of listing people in a critical area, and/or assigning resources to the people actually in need, an operator sees a display of any portion of a map containing tracked assets. An example is shown in FIG. 5. Then, the operator selects a drawing tool. An example is shown in FIG. 6, in which the operator selects a drawing tool on the left hand side of the screen. Then, the operator selects the area in which the assets should be contacted. An example is shown in FIG. 7. In response, a list of all people currently within the area selected is shown immediately. All people (or a portion thereof) can be assigned to an operator to divide the work amongst operators. Also, as soon as an asset leaves the area, it will automatically be dropped off the list. The same is true for a check-in event within one of the save-haven GeoFences/zones. An example of a map and a displayed list is shown in FIG. 9.

### SMS Zipping

For position reporting, there is a problem in that in some areas GPRS/Edge/3G/LTE connectivity is poor and no reliable data-connection can be established to transfer tracking data via a secure connection to the remove server. In the case in which an asset is tracked, regular signal transmissions are required. Sending a SMS typically costs between US $0.05 and US $0.50 and it is essential to transfer as much data as possible, including but not limited to: past positions including timestamps, accuracy, battery-status, velocity, direction, mobile country code (MCC), mobile network code (MNC), location area code (LAC), cellular-ID (CID), etc. Depending on the polling interval cost can easily surmount to hundreds of dollars if no intelligent compression algorithm is found. A default short message service (SMS) message, if sent in ASCII is limited to 160 characters and does not provide much space to send information. A solution is for a packing algorithm charset to be limited to the HEX characters (0123456789ABCDEF). Hence there are just 16 possible characters and we can reduce the normal 1 byte (8 bits) per character to only 4 bits (2̂4=16). So in one byte two characters are represented instead of one (Reduction of 50%). If the text to be packed has uneven characters e.g. 3 characters then they have to be packed on 2 bytes (16 bits) and the last 4 bits will have just zeros (In this case the reduction is not 50% and only for the last uneven character. For all 2n characters before the reduction is 50%.). The zero (“0” is used as a information relevant character in the data) padded nybble has no impact to the understanding of the decoded data because the length of the transmitted data is so it is just skipped. In an example, Char “1” is in bits “0001” and char “2” is in bits “0010”. Instead of using a whole byte for one char (like ASCII) e.g. “1”=>“0000 0001” two characters are “packed” (with bit shifting operations) in one byte “12”=>“0001 0010”. “Unpacking” is done by just reverting this shifting operations from 4 bits to 8 bits (1 byte) and casting the byte back to a character (e.g. UTF-8).

More generally, the usual SMS characters are compressed into a smaller representation which uses fewer bits than a conventional representation. For example an eight bit representation may be compressed into a 7 bit representation, a 6 bit representation, a 5 bit representation, or a 4 bit representation. The compressed representation may be decompressed at the receiving end, as would be clear to one skilled in the art. The degree of compression provides a cost saving and an energy saving in data transmission in accordance with the degree of compression.

### Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

1. A method of generating an alert message in a monitoring system for monitoring a plurality of mobile devices registered at a server, the system comprising the server and the plurality of mobile devices registered at the server, the plurality of mobile devices including a first mobile device, the method comprising the steps of:
(i) each mobile device acquiring location data;
(ii) each mobile device sending the acquired location data to the server via a telecommunications network;
(iii) the server storing a time series of location data for each device;
(iv) the server extrapolating a location of the first mobile device, and
(v) the server generating the alert message which identifies the first mobile device in response to an extrapolated position of the first mobile device satisfying a condition.

2. Method of claim 1, wherein the condition is an extrapolated location of the first mobile device entering a Geofence region.

3. Method of any previous claim, wherein the server extrapolates a location of the first mobile device by forming a circle around the present position, the circle having a radius.

4. Method of claim 3, wherein the circle radius is a predefined amount of time multiplied by an assumed speed.

5. Method of any previous claim, wherein the server extrapolates a location of the first mobile device by calculating routes to be covered within a predefined amount of time.

6. Method of any of claims 1 to 4, wherein the server extrapolates a location of the first mobile device by calculating routes to get to a predefined position within a predefined about of time.

7. Method of claim 5 or 6, wherein calculated routes are all viable routes.

8. Method of any of claims 5 to 7, the method including the step of the server detecting the mode of travelling of the first mobile device, and using this detected mode in route calculation.

9. Method of claim 8, wherein the mode of travelling is walking, in a vehicle, on a train, or on a bicycle.

10. Method of claim 8 or 9, wherein the mode of travelling is a weighted average.

11. Method of claim 1 or 2, wherein the server extrapolates a location of the first mobile device using historic tracking data.

12. Method of claim 11, including the step of the server detecting the mode of travel of the first mobile device, and using this mode of travel in selecting historic tracking data from a store of historic tracking data.

13. Method of claim 11 or 12, wherein the server extrapolates a location of the first mobile device using historic tracking data to provide a set of paths, each with an associated probability.

14. Method of claim 13 wherein if the predicted paths and time dependences fail to agree with arriving at a particular destination by a particular time, an alert is generated for a user of the first mobile device that they are projected to arrive late at the particular destination by the particular time.

15. Method of any previous claim including the step of an alert being generated if an extrapolated position of the first mobile device is within a predefined distance of a geofenced region.

16. Method of any previous claim including the step of an alert being generated if an extrapolated position of the first mobile device is within a predefined travel time of a geofenced region.

17. Method of any previous claim wherein the first mobile device includes an integral GPS receiver, and location data for the first mobile device corresponds to a GPS location of the first mobile device.

18. Monitoring system for monitoring a plurality of mobile devices registered at a server, the system comprising the server and the plurality of mobile devices registered at the server, the plurality of mobile devices including a first mobile device, wherein
(i) each mobile device is arranged to acquire location data;
(ii) each mobile device is configured to send the acquired location data to the server via a telecommunications network;
(iii) the server is configured to store a time series of location data for each device;
(iv) the server is arranged to extrapolate a location of the first mobile device, and
(v) the server is configured to generate an alert message which identifies the first mobile device in response to an extrapolated position of the first mobile device satisfying a condition.

19. Monitoring system of claim 18, arranged to perform the method of any of claims 1 to 17.

20. The server of claim 18 or 19.

21. The first mobile device of claim 18 or 19.

22. Computer program product embodied on a non-transient storage medium, the computer program product when running on a server operable to generate an alert message in a monitoring system for monitoring a plurality of mobile devices registered at a server, the system comprising the server and the plurality of mobile devices registered at the server, the plurality of mobile devices including a first mobile device, the computer program product operable to:
(i) receive location data acquired by each mobile device and sent to the server via a telecommunications network;
(ii) store at the server a time series of location data for each device;
(iii) extrapolate at the server a location of the first mobile device, and
(iv) generate at the server the alert message which identifies the first mobile device in response to an extrapolated position of the first mobile device satisfying a condition.

23. Computer program product of claim 22, operable to perform the method of any of claims 1 to 17.
